(19) United States
(12) Patent Application Publication
(10) Pub. No.: US 2020/0382489 A1
(43) Pub. Date: Dec. 3, 2020

(54) REGISTRATION INFORMATION PROCESSING METHOD AND SYSTEM, TERMINAL DEVICE AND CONTROL DEVICE

(71) Applicant: SZ DJI TECHNOLOGY CO., LTD., Shenzhen (CN)

(72) Inventors: Guofang ZHANG, Shenzhen (CN); Yun YU, Shenzhen (CN)

(21) Appl. No.: 16/828,614

(22) Filed: Mar. 24, 2020

Related U.S. Application Data
(63) Continuation of application No. PCT/CN2017/105340, filed on Oct. 9, 2017.

(51) Int. Cl. H04L 29/06; H04W 12/06; G06K 17/00; B64C 39/02

(52) U.S. Cl. CPC H04L 63/0823; B64C 39/024; G06K 17/0022; H04W 12/06

(57) ABSTRACT

The present disclosure provides a registration information processing method. The registration information processing method includes obtaining identity information of a registrant holding an unmanned aerial vehicle (UAV) from a terminal device; generating a registration certificate based on the identity information of the registrant; obtaining device information of at least one UAV held by the registrant from the terminal device; and associating the device information of the at least one UAV with the registration certificate.

### CROSS-REFERENCE TO RELATED APPLICATION

This application is a continuation of International Application No. PCT/CN2017/105340, filed on Oct. 9, 2017, the entire content of which is incorporated herein by reference.

### TECHNICAL FIELD

The present disclosure generally relates to the field of information processing and, more particularly, relates to a registration information processing method and system, a terminal device and a control device.

### BACKGROUND

With development of flight technology, aircrafts, such as unmanned vehicles or unmanned aerial vehicles (UAVs), have developed from military use to more and more civil use including, UAV plant protection, UAV aerial photography, UAV forest fire-alarm monitoring, etc. Civilianization is also the trend of the future development of UAVs.

With the rapid development of the UAV industry and the dramatic increase in UAV operations, UAV accidents and incidents occur frequently. Many countries have issued regulations on real-name registration and management of UAVs. Because the amount for registration of the UAVs is huge and grows rapidly, this may lead to a situation that no remaining registration number is available after a short period, or the registration numbers are used up rapidly. In addition, in order to register a large number of UAVs, the registration number may be very complicated and lengthy. However, an UAV may not have sufficient space to post such a lengthy registration number there on.

### SUMMARY

One aspect of the present disclosure provides a registration information processing method. The registration information processing method includes obtaining identity information of a registrant holding an unmanned aerial vehicle (UAV) from a terminal device; generating a registration certificate based on the identity information of the registrant; obtaining device information of at least one UAV held by the registrant from the terminal device; and associating the device information of the at least one UAV with the registration certificate.

Another aspect of the present disclosure provides a registration information processing system. The registration information processing system includes a memory, configured to store program instructions; and a processor, configured to call the program instructions to implement a registration information processing method. The registration information processing method includes obtaining identity information of a registrant holding an unmanned aerial vehicle (UAV) from a terminal device; generating a registration certificate based on the identity information of the registrant; obtaining device information of at least one UAV held by the registrant from the terminal device; and associating the device information of the at least one UAV with the registration certificate.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions in the embodiments of the present disclosure, the drawings that need to be used in the description of the embodiments will be briefly described below. It is obvious that the drawings in the following description are some embodiments of the present disclosure, and for those of ordinary skill in the art, other drawings may also be obtained according to these drawings without any creative effort.

FIG. 1 illustrates a schematic flowchart of an exemplary registration information processing method according to an embodiment of the present disclosure;

FIG. 2 illustrates a schematic diagram of interaction between a registration information processing system and a terminal device according to an embodiment of the present disclosure;

FIG. 3 illustrates a schematic diagram of associating device information of a UAV with a registration certificate generated from identity information according to an embodiment of the present disclosure;

FIG. 4 illustrates a schematic diagram of obtaining device information of a UAV through a terminal device according to an embodiment of the present disclosure;

FIG. 5 illustrates a schematic diagram of binding a UAV with a registrant through a registration certificate according to an embodiment of the present disclosure;

FIG. 6 illustrates a schematic flowchart of an exemplary registration information processing method according to an embodiment of the present disclosure;

FIG. 7 illustrates a schematic flowchart of an exemplary registration information processing method according to an embodiment of the present disclosure;

FIG. 8 illustrates a schematic diagram of interaction between a terminal device, a registration information processing system, and a control device according to an embodiment of the present disclosure; and

FIG. 9 illustrates a schematic structural diagram of a registration information processing system, a terminal device, or a control device according to an embodiment of the present disclosure.

### DETAILED DESCRIPTION OF THE EMBODIMENTS

In the following, the technical solutions in the embodiments of the present disclosure will be clearly described with reference to the accompanying drawings in the embodiments of the present disclosure. It is obvious that the described embodiments are only a part of the embodiments of the present invention, but not all of the embodiments. All other embodiments obtained by those skilled in the art based on the embodiments of the present disclosure without creative efforts are within the scope of the present disclosure.

It should be noted that when a component is referred to as being “fixed” to another component, it can be directly on the other component or an intermediate component may be present. When a component is considered as “connected to” another component, it can be directly connected to another component or both may be connected to an intermediate component.

All technical and scientific terms used herein have the same meaning as commonly understood by one of ordinary skill in the art to which this disclosure belongs, unless otherwise defined. The terminology used in the description of the present disclosure is for the purpose of describing particular embodiments and is not intended to limit the disclosure. The term “and/or” used herein includes any and all combinations of one or more of the associated listed items.

Some embodiments of the present disclosure are described in detail below with reference to the accompanying drawings. The features of the embodiments and examples described below can be combined with each other without conflict.

The following describes how to process registration information for an unmanned aerial vehicle (UAV), and how to control the flight of the UAV based on the registration information.

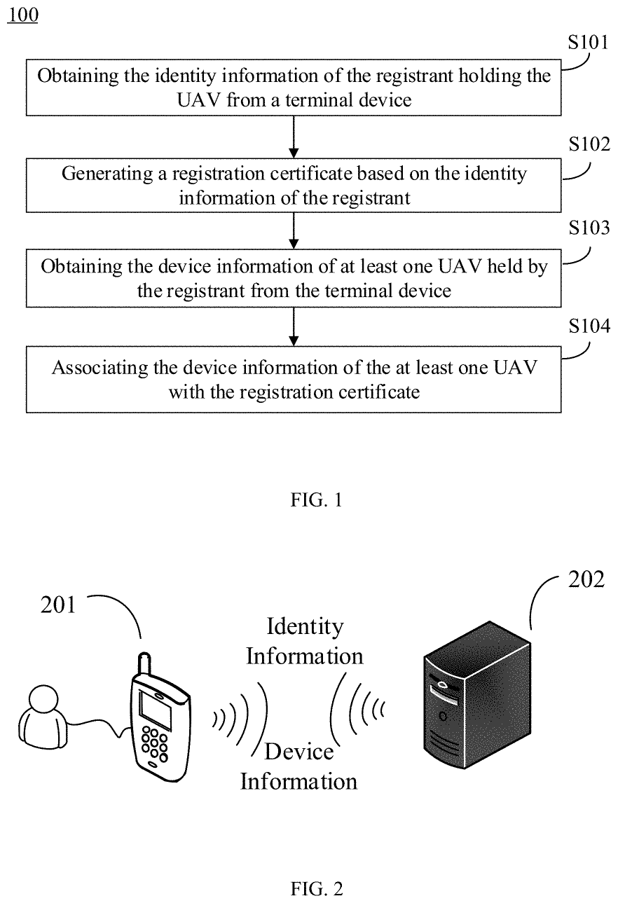

The present disclosure provides a registration information processing method for UAVs. FIG. 1 illustrates a schematic flowchart of an exemplary registration information processing method according to an embodiment of the present disclosure. Referring to FIG. 1, the registration information processing method 100 may include the following exemplary steps.

In S101, the method may include obtaining the identity information of the registrant holding the UAV from a terminal device.

For example, the method may be implemented by a registration information processing system. The registration information processing system may be a server. FIG. 2 illustrates a schematic diagram of interaction between a registration information processing system and a terminal device according to an embodiment of the present disclosure. Referring to FIG. 2, a terminal device 201 may be able to obtain identity information of a registrant holding a UAV, and send the identity information of the registrant to a registration information processing system 202. Further, the terminal device 201 may be configured to include an interactive device. The terminal device 201 may be able to obtain the identity information inputted through the interactive device. The terminal device 201 may be able to send the obtained identity information to the registration information processing system 202. The terminal device 201 may be a terminal device installed for UAV registration. The terminal device 201 may be one or more of a remote controller, a smart phone, a tablet computer, a laptop computer, and a wearable device (watch or bracelet).

In one embodiment, the obtaining the identity information of the registrant holding the UAV from the terminal device may include: obtaining an application request for the registration certificate sent by the terminal device; and in response to the application request for the registration certificate, obtaining the identity information of the registrant.

For example, the registration information processing system may obtain an application request for the registration certificate sent by the terminal device. After obtaining the application request for the registration certificate, the registration information processing system may receive the identity information of the registrant sent by the terminal device through a communication interface connecting with the terminal device. Further, when a user wants to apply for a registration certificate according to the identity information of the registrant, the user may perform a registration certificate application operation on the interactive device of the terminal device, and the terminal device may determine the application request for the registration certificate according to the detected application operation. The terminal device may send the application request to a registration information processing device to instruct the registration information processing system to receive the identity information of the registrant. In addition, the user may input the identity information of the registrant through the interactive device, and the terminal device may be able to obtain the identity information inputted through the interactive device.

In one embodiment, the registrant may be a person, a company, a government agency, a social group, etc. The user mentioned above may be the registrant itself. For example, the registrant is a user who purchases or holds the UAV, and in this case, the user may be the registrant. In some other embodiments, the user may be an employee of the registrant who performs the registration operation. For example, when the registrant is a UAV company, the user in this case may be an employee of the company who performs the UAV registration operation.

In one embodiment, the identity information of the registrant may include at least one of the information of the certificate hold by the registrant, the biological information of the registrant, or the business information of the registrant.

For example, when the registrant is a person, the identity information of the registrant may be document information (e.g., identity card information, passport information, green card information, cell-phone number or driving license information based on real-time authentication, etc.) and/or biological information (e.g., fingerprint information or iris information, etc.).

When the registrant is an enterprise, the identity information of the registrant may be business information, which may include any legal information registered at a business supervision department by the registrant, including business registration information and/or tax registration information.

In S102, the method may include generating a registration certificate based on the identity information of the registrant.

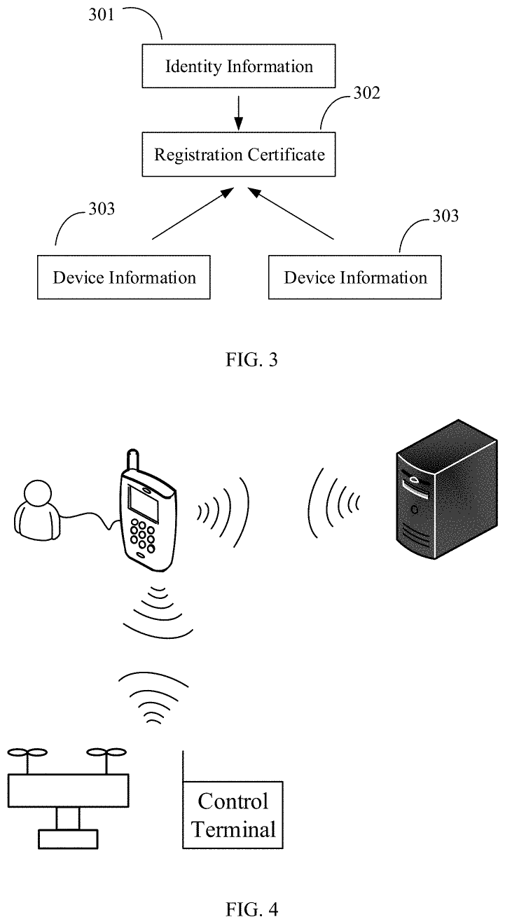

FIG. 3 illustrates a schematic diagram of associating device information of a UAV with a registration certificate generated from identity information according to an embodiment of the present disclosure. Referring to FIG. 3, in one embodiment, after receiving the identity information 301, the registration information processing system may generate a registration certificate 302 based on the identity information 301. The registration certificate 302 may be in correspondence with the identity information 301. That is, the registration certificate 302 and the identity information 301 may be bound together. The registration certificate 302 may be digital information. In one embodiment, the registration certificate 302 may have various forms, such as a serial number, a two-dimensional code, a barcode, etc.

In one embodiment, when the identity information of the registrant passes authentication, the registration certificate may be generated based on the identity information of the registrant.

For example, when the registration information processing system obtains the identity information, the registration information processing system may not directly generate a registration certificate for the identity information. A registration certificate may be generated based on the identity information only when the registration information processing system confirms that the identity information passes the authentication. When the identity information authentication fails, the registration information processing system may refuse to generate a registration certificate based on the identity information, and may send a terminal application failure notification message to the terminal device. In addition, the registration information processing system may also return the reason for the failure of the registration certificate application. As such, registrants not meeting the conditions for applying for registration certificates, meeting the requirements for using UAV, or providing false identity information may be prevented from applying for registration certificates.

In one embodiment, the registration information processing system may be able to authenticate the identity information of registrants.

For example, after obtaining the identity information, the registration information processing system may need to authenticate the obtained identity information to determine whether the registrant corresponding to the identity information meets the conditions for applying for a registration certificate. The identity information may be authenticated using one of the following exemplary methods.

A method for authenticating identity information may include: sending the identity information of the registrant to an identity-information management and authentication system, and receiving the authentication result sent by the identity-information management and authentication system. For example, the identity-information management and authentication system may be any system that can authenticate identity information, and the identity-information management and authentication system may be a system independent of the registration information processing system. In one embodiment, the identity-information management and authentication system may be a server, and the identity-information management and authentication system may be a system through which a regulatory authority supervises registrants. For example, the identity-information management and authentication system may be one or more of a civil aviation regulatory authority, a public security regulatory authority, an agricultural regulatory authority, a business regulatory department, a homeland regulatory authority, or a military regulatory authority. The identity-information management and authentication system may authenticate the received identity information, for example, verify whether the identity information is real and valid, and verify whether the registrant corresponding to the identity information meets the requirements for applying for a registration certificate or using a UAV. After the authentication is completed, the authentication result may be sent to the registration information processing system.

Another method for authenticating identity information may include: authenticating the identity information according to a preset authentication requirement. For example, after obtaining the identity information, the registration information processing system may authenticate the identity information according to a preset authentication requirement, and the authentication process may be performed by the registration information processing system. For example, the registration information processing system may verify whether the identity information is real and valid, and verify whether the registrant corresponding to the identity information meets the requirements for applying for a registration certificate or using a UAV.

When the authentication is passed, a registration certificate may be generated based on the identity information.

In S103, the method may include obtaining the device information of at least one UAV held by the registrant from the terminal device.

For example, each UAV may have corresponding device information. The device information may be information indicating one or more of the manufacturer of the UAV, the model of the UAV, the serial number of the UAV, the use of the UAV, etc. In one embodiment, the device information of a UAV may include at least one of the manufacturer, the device model, or the serial number.

After obtaining the device information of the at least one UAV held by the registrant, the terminal device may send the device information to the registration information processing system. The registration information processing system may receive the device information of the at least one UAV held by the registrant sent by the terminal device through a communication interface with the terminal device. The at least one UAV held by the registrant may be a UAV purchased by the registrant, a UAV produced by the registrant, a UAV used by the registrant, or a UAV supervised by the registrant.

In one embodiment, the terminal device may obtain the device information of the at least one UAV inputted by the user through the interactive device.

In one embodiment, the user may operate the interactive device of the terminal device to input the device information of the at least one UAV. For example, when the user purchases a UAV, the user may operate the interactive device that displays a UAV registration interface and enter the device information of the purchased UAV.

In one embodiment, the terminal device may obtain the device information of the at least one UAV through a communication interface between the device terminal and the at least one UAV or a control terminal of the at least one UAV.

FIG. 4 illustrates a schematic diagram of obtaining device information of a UAV through a terminal device according to an embodiment of the present disclosure. Referring to FIG. 4, in one embodiment, the terminal device may be connected to the UAV or the control terminal of the UAV through a communication interface. The communication interface may be a wired communication interface or a wireless communication interface. The terminal device may send a device information acquisition request to the UAV or the control terminal of the UAV. Therefore, through this method, the device information of the UAV may be accurately and quickly obtained, and thus the problems such as input errors or input delays caused by manual input may be avoided.

In S104, the method may include associating the device information of the at least one UAV with the registration certificate.

For example, referring to FIG. 3, after obtaining the device information 303 of the UAV and generating the registration certificate 302, the registration information processing system may associate the device information of the UAV with the registration certificate, that is, bind the device information of the UAV to the registration certificate. As such, after binding, each UAV may correspond to a registration certificate 302, and the correspondence between the registration certificate 302 and the device information 303 of the UAV that is associated with the registration certificate may be stored.

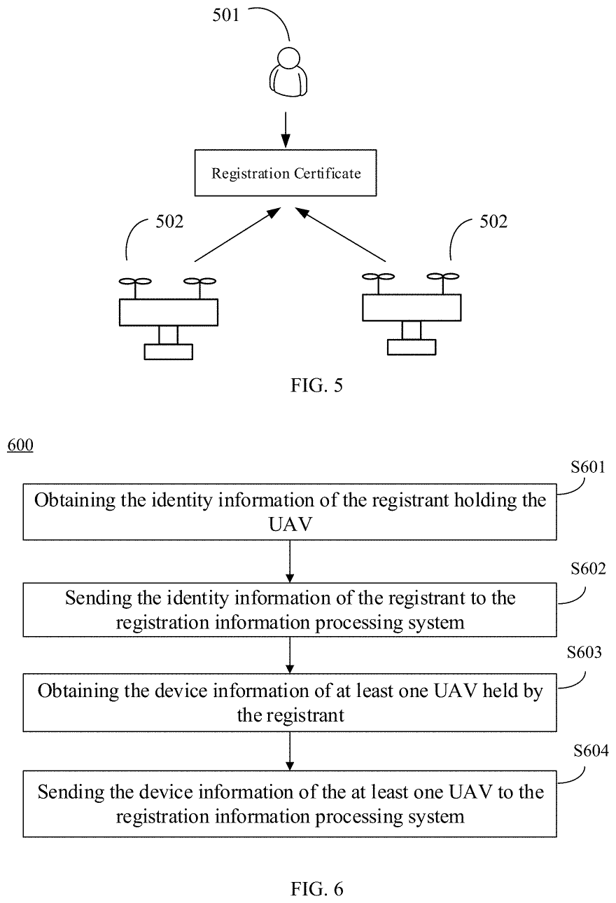

FIG. 5 illustrates a schematic diagram of binding a UAV with a registrant through a registration certificate according to an embodiment of the present disclosure. Referring to FIG. 5, it should be noted that, the identity information may represent the registrant 501, and through generating a registration certificate based on the identity information, and binding the device information of the UAV 502 to the registration certificate, the device information of the UAV 502 may be actually bound to the UAV through the registration certificate. As such, binding and registering a UAV through the identity information of the registrant may be able to effectively solve the problem that the registration numbers of UAVs are used up rapidly.

In one embodiment, it may be determined whether the device information of the UAV meets a preset association requirement, and when the association requirement is met, the device information may be associated with the registration certificate.

For example, the registration information processing system may determine whether the device information meets a preset association requirement. In one embodiment, the registration information processing system may determine whether the device information is real and valid, and when the device information is real and valid, the device information may be associated with the registration certificate; otherwise, the registration information processing system may refuse to associate the device information with the registration certificate. In another example each registration certificate may only be bound to a UAV with a preset type, model, or use. The registration information processing system may determine whether the UAV corresponding to the device information is a UAV with the preset type, model, or use based on the device information. When it is determined that the UAV corresponding to the device information is a UAV with the preset type, model, or use, the device information may be associated with the registration certificate; otherwise, associating the device information with the registration certificate may be refused, that is, the device information may not be associated with the registration certificate.

In some embodiments, more then one piece of device information may be associated with the registration certificate.

In one embodiment, a quantity of pieces of device information that have been associated with the registration certificate may be determined, and when the quantity is less than a preset quantity threshold, the device information may be associated with the registration certificate.

In one embodiment, the quantity of the pieces of UAV device information that can be associated with a registration certificate may have a limit. When the registration information processing system obtains the device information sent by the terminal device, it may query the quantity of the pieces of UAV device information that are currently associated with the registration certificate. When the quantity is greater than or equal to a preset quantity threshold, associating the obtained device information with the registration certificate may be rejected, an association failure notification message may be sent to the terminal device, and the reason for the association failure may also be sent to the terminal device. At the same time, the user may be reminded to apply for a new registration certificate. When the quantity is determined to be less than the preset quantity threshold, the device information may be associated with the registration certificate.

In one embodiment, associating the device information of the at least one UAV with the registration certificate may include: generating corresponding authentication information for each UAV in the at least one UAV, and the corresponding authentication information of each UAV may include a registration certificate.

For example, when the registration information processing system associates the device information of UAVs with registration certificates, authentication information may be generated for each UAV, and this authentication information may include a registration certificate. The authentication information may be credentials indicating that the UAV is registered or authenticated, and may be a certificate for the UAV to legally fly.

In one embodiment, generating corresponding authentication information for each of the at least one UAV may include: determining a distinguishing code for each of the at least one UAV with the distinguishing code used for distinguishing the UAV within the at least one

UAV; and combining the distinguishing code and the registration certificate of each UAV to obtain the corresponding authentication information of the UAV.

For example, the registration information processing system may determine a distinguishing code for each UAV. The distinguishing code may be used to distinguish each UAV of the at least one UAV. Each UAV associated with a registration certificate may individually correspond to a unique distinguishing code, and the registration information processing system may combine the distinguishing code and the registration certificate for each UAV, such that the corresponding authentication information of each UAV may be obtained.

In one embodiment, the distinguishing code may be determined for each UAV based on the device information of the UAV.

For example, the registration information processing system may be able to generate a distinguishing code for each UAV based on the obtained device information of the UAV. The distinguishing code may be generated through the following exemplary methods.

A method of generating the distinguishing code may include determining the device information of the UAV as the distinguishing code. For example, the registration information processing system may determine the device information as a distinguishing code, and correspondingly, the authentication information of the UAV may include the registration certificate and the device information of the UAV.

Another method of generating the distinguishing code may include generating the distinguishing code based on the device information. For example, in some cases, the device information of a UAV may be generally lengthy, and thus the registration information processing system may generate a distinguishing code based on the device information. The distinguishing code may be relatively simple, such as a number, a letter, a letter string, or a string combining numbers and letters, etc. For example, when a registrant has four UAVs, based on the device information of the UAVs, the corresponding distinguishing codes generated for the UAVs may respectively be 1, 2, 3, and 4, or A, B, C, and D.

It should be noted that those skilled in the art may also determine the distinguishing code of the UAV by other methods, which are not specifically limited here.

In one embodiment, the registration certificate may be sent to the terminal device. For example, after the registration information processing system generates a registration certificate according to the identity information, the registration information processing system may send the registration certificate to the terminal device. After receiving the registration certificate sent by the registration information processing system, the terminal device may store the registration locally. Or the registration certificate may be presented to the user, for example, may be displayed in a digital form, or in a pattern (for example, a two-dimensional code).

In one embodiment, the registration information processing system may obtain the contact information of the registrant; and send the registration certificate based on the contact information.

For example, after the registration information processing system generates a registration certificate according to the identity information, the registration information processing system may obtain the contact information entered by the user and may send the registration certificate through the contact information. The registration certificate may be sent in a digital form or a pattern form. The contact information may include, but is not limited to, a mobile phone number, an email, or an instant messaging service number.

In one embodiment, the corresponding authentication information of each UAV may be sent to the terminal device.

For example, the registration information processing system may send the corresponding authentication information of each UAV to the terminal device through the communication interface with the terminal device. The terminal device may display the authentication information in a preset form after receiving the authentication information, such that the user may know the authentication or registration status corresponding to each UAV.

In one embodiment, sending the corresponding authentication information of each UAV to the terminal device may include: when the authentication information includes a distinguishing code for distinguishing the UAV within the at least one UAV, and the distinguishing code is different from the device information, sending the device information and the corresponding authentication information of each of the at least one UAV to the terminal device.

For example, when the authentication information includes a distinguishing code, the distinguishing code may be different from the device information of the corresponding UAV. In this case, when the authentication information is directly sent to the terminal device, it may be difficult for the terminal device to associate the device information of the UAV with the corresponding authentication information of the UAV. Therefore, the registration information processing system may send the authentication information and corresponding device information of each of the at least one UAV to the terminal device. As such, the terminal device may receive the authentication information and corresponding device information of each UAV in the at least one UAV, and then may associate the authentication information with its corresponding device information, that is, may let the user know the corresponding authentication information of each UAV.

In one embodiment, associating the device information of the at least one UAV with the registration certificate may include: storing the association relationship between the registration certificate and the device information of the at least one UAV in a local database.

For example, the registration information processing system may include a local database, and the registration information processing system may record the corresponding relationship between the registration certificate and the device information of the UAV in the local database. Thus, binding between the UAV and the registration certificate may be realized.

In one embodiment, a query request, containing the identity information of the registrant or the device information of the UVA, may be obtained; the registration certificate may be queried based on the identity information of the registrant or the device information of the UVA; and in response to the query request, a query response may be sent based on the acquired registration certificate.

For example, the registration information processing system may obtain a query request. The query request may be a request for querying a registration certificate. The query request may come from the terminal device or another query terminal. The query terminal may be a smart phone, a tablet computer, a laptop computer, or any other appropriate handheld query terminal. The query request may contain identity information of the registrant or the device information of the UAV.

In some embodiments, the user may input the identity information of the registrant through the interactive device of the terminal device. The terminal device may send a query request containing the identity information to the registration information processing system, and the registration information processing system may query the corresponding registration certificate according to the identity information. When the registration certificate is identified, a query response may be sent to the terminal device. The query response may be information indicating that there is a registration certificate corresponding to the identity information, that is, a registration certificate exists for the registrant corresponding to the identity information. The query response may include the registration certificate. The query response may also include the device information of the UAV that is associated with the registration certificate. When the registration certificate is unable to be identified, a query response may be sent to the terminal device, and the query response may be information indicating that no registration certificate exists in correspondence with the identity information.

In some embodiments, the user may input the device information of the UAV through the interactive device of the terminal device, the terminal device may send a query request containing the device information of the UAV to the registration information processing system, and the registration information processing system may query the corresponding registration certificate based on the device information. When the registration certificate is identified, a query response may be sent to the terminal device. The query response may be information indicating that there is a registration certificate corresponding to the device information, that is, a registration certificate exists for the UAV corresponding to the device information. The query response may include the registration certificate. The query response may also include the identity information that is associated with the registration certificate. When the registration certificate is unable to be identified, a query response may be sent to the terminal device, and the query response may be information indicating that no registration certificate exists in correspondence with the device information.

In some embodiments, the query request may be sent from a handheld query terminal of a relevant law enforcement officer. The law enforcement officer may obtain the identity information of the registrant or the device information of the UAV through the handheld terminal, and may send the query request to the registration information processing system. Through this method, the law enforcement officer may be able to check whether the registrant has a registration certificate, the detailed information of the registration certificate (such as the registration certificate number, the time when the registration certificate was obtained, or the place where the registration certificate was obtained, etc.), the UAVs associated with the registration certificate of the registrant, or may be able to query whether a certain UAV has a corresponding registration certificate, the detailed information of the registration certificate, the identity information of the registrant corresponding to the registration certificate, so as to supervise the management of UAVs or registrants.

In one embodiment, the association between the registration certificate and the device information of the UAV that has been associated with the registration certificate may be cancelled.

For example, the situation of registrants holding UAVs may change frequently, which may cause a UAV that is associated with a registration certificate to be no longer used. For example, a UAV may be scrapped, a UAV may be deactivated, etc. The registration information processing system may be able to cancel the association between the registration certificate and the device information of the UAV that has been associated with the registration certificate. In one embodiment, the user may input the device information or the distinguishing code of the UAV whose association is intended to be cancelled through the interactive device of the terminal device. Further, the terminal device may send a disassociation request to the registration information processing system.

The disassociation request may include a piece of device information or a distinguishing code of a target associated UAV, and the target associated UAV may be a UAV, among the UAVs that have been associated with registration certificates, whose association is intended to be cancelled. After receiving the disassociation request, the registration information processing system may cancel the association relationship between the target associated UAV and the registration certificate according to using the device information and the distinguishing code in the request.

FIG. 6 illustrates a schematic flowchart of an exemplary registration information processing method according to an embodiment of the present disclosure. Referring to FIG. 6, the registration information processing method 600 may be implemented by a terminal device. The method may include at least part of the following exemplary steps:

In S601, obtaining the identity information of the registrant holding the UAV;

In S602, sending the identity information of the registrant to a registration information processing system, so that the registration information processing system generates a registration certificate based on the identity information of the registrant;

In S603, obtaining the device information of at least one UVA held by the registrant; and

In S604, sending the device information of the at least one UAV to the registration information processing system, so that the registration information processing system associates the registration certificate with the device information of the at least one UAV.

In one embodiment, the terminal device may be a terminal device consistent with various embodiments described above. For principles and explanations, reference may be made to the corresponding content in the embodiments provided above, and the details are not described herein again.

In one embodiment, obtaining the identity information of the registrant holding the UAV may include:

determining an application request for the registration certificate according to a detected registration certificate application operation;

sending the application request for the registration certificate to a registration information processing system; and

obtaining the identity information of the registrant inputted through an interactive device.

In one embodiment, obtaining the device information of the at least one UAV held by the registrant may include:

obtaining the device information of the at least one UAV inputted through an interactive device.

In one embodiment, obtaining the device information of the at least one UAV held by the registrant may include:

obtaining the device information of the at least one UAV through a communication interface with the at least one UAV or a control terminal of the UAV.

In one embodiment, the method may further include:

receiving the registration certificate sent by the registration information processing system.

In one embodiment, the method may further include:

sending the registration certificate to one or more UAVs or UAV control terminals of the at least one UAV.

For example, when the one or more UAVs are connected to the terminal device, or the control terminals of the one or more UAVs are connected to the terminal device, the terminal device may send the registration certificate to the UAV or the UAV control terminal, and when the UAV or the UAV control terminal receives the registration certificate, the control device inside the UAV or the UAV control terminal may lift the flight restrictions on the UAV.

In one embodiment, sending the registration certificate to the one or more UAVs or UAV control terminals of the at least one UAV may include: sending the device information and the registration certificate of the corresponding UAV to the one or more UAVs or UAV control terminals of the at least one UAV.

For example, the terminal device may also be able to send the device information of the one or more UAVs to a corresponding UAV or UAV control terminal. When the UAV or the UAV control terminal receives the device information, the control device inside the UAV or the UAV control terminal may compare the device information in the received message with the device information of the UAV owned by itself. When the received device information matches the owned one, the flight restrictions on the UAV may be lifted, and when he received device information does not match the owned one, lifting the flight restrictions on the UAV may be refused.

In one embodiment, the method may further include receiving the corresponding authentication information of each of the at least one UAV sent by the registration certificate processing system. The authentication information may include the registration certificate.

In one embodiment, the corresponding authentication information of each UAV may further include a distinguishing code for distinguishing the UAV within the at least one UAV.

In one embodiment, the distinguishing code may be determined based on the device information of the UAV.

In one embodiment, the method may further include sending the authentication information to one or more UAVs or UAV control terminals of the at least one UAV.

For example, when the one or more UAVs are connected to the terminal device, or the control terminals of the one or more UAVs are connected to the terminal device, the terminal device may send the authentication information to the UAV or the UAV control terminal, and when the UAV or the UAV control terminal receives the authentication information, the control device inside the UAV or the UAV control terminal may lift the flight restrictions on the UAV.

In one embodiment, sending the authentication information to the one or more UAVs or UAV control terminals of the at least one UAV may include: sending the device information and the authentication information of the corresponding UAV to the one or more UAVs or UAV control terminals of the at least one UAV.

For example, the terminal device may also be able to send the device information of the one or more UAVs to a corresponding UAV or UAV control terminal. When the UAV or the UAV control terminal receives the device information, the control device inside the UAV or the UAV control terminal may compare the device information in the received message with the device information of the UAV owned by itself. When the received device information matches the owned one, the flight restrictions on the UAV may be lifted, and when he received device information does not match the owned one, lifting the flight restrictions on the UAV may be refused.

In one embodiment, receiving the corresponding authentication information of each of the at least one UAV sent by the registration certificate processing system may include:

when the authentication information includes a distinguishing code for distinguishing the UAV within the at least one UAV, and the distinguishing code is different from the device information, receiving the device information and the corresponding authentication information of each of the at least one UAV sent by the registration information processing system.

In one embodiment, the identity information of the registrant may include at least one of the information of the certificate hold by the registrant, the biological information of the registrant, or the business information of the registrant.

In one embodiment, the device information of the UAV may include at least one of the manufacturer, the device model, or the serial number.

It should be understood that, for the implementation of the various embodiments of the method 600, reference may be made to the description of the method 100, and the details of the implementation are not described herein again.

According to the disclosed registration information processing method, the terminal device obtains the identity information of the registrant holding the UAV. The registration information processing system generates a registration certificate based on the identity information of the registrant and obtaining the device information of at least one UAV held by the registrant. The registration information processing system associates the registration certificate with the device information of the at least one UAV. Asa such, wasting registration number and using up the registration numbers rapidly during the UAV registration process may be avoided, and wasting the space of UAV or causing UAV to have insufficient space due to the excessively lengthy registration number may also be avoided. Further, by associating the device information of the UAV with the registration certificate, the registration certificate can be obtained based on the identity information, thereby achieving effective and orderly control of each UAV.

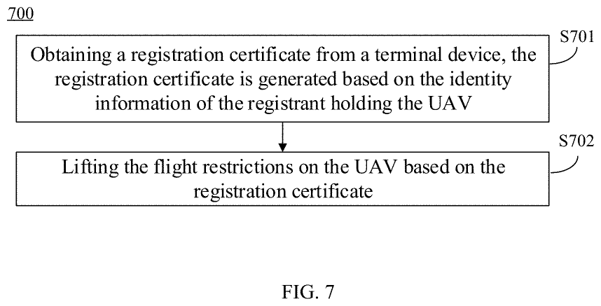

FIG. 7 illustrates a schematic flowchart of an exemplary registration information processing method according to an embodiment of the present disclosure. Referring to FIG. 7, the registration information processing method 700 may be implemented by a terminal device. The method may include at least part of the following exemplary steps.

In S701, a registration certificate may be obtained from a terminal device. The registration certificate may be generated based on the identity information of the registrant holding the UAV.

In one embodiment, the control device may be disposed on the UAV. In other embodiments, the control device may be disposed on a control terminal of the UAV. In one embodiment, the control device may directly obtain the registration certificate from the terminal device, or may indirectly obtain the registration certificate from the terminal device. When the registration certificate is directly obtained from the terminal device, and the control terminal is disposed on the UAV or on the control terminal, the UAV or the control terminal may be connected to the terminal device through a communication interface, and the control device may directly obtain the registration certificate from the terminal device. When the registration certificate is indirectly obtained from the terminal device, and the control device is disposed on the UAV, the control terminal of the UAV may be directly connected to the terminal device through a communication interface, the terminal device may be able to send the registration certificate of the UAV to the control terminal, and through the communication connection between the control terminal and the UAV, the control device on the UAV may be able to obtain the registration certificate from the control terminal.

In S702, flight restrictions on the UAV may be lifted based on the registration certificate.

In one embodiment, when obtaining the registration certificate from the terminal device, the message obtained by the UAV or the UAV control terminal from the terminal device may further include device information, and lifting the flight restrictions on the UAV based on the registration certificate may include when the device information obtained from the terminal device matches the device information of the UAV, lifting the flight restrictions on the UAV based on the registration certificate.

In one embodiment, the method 700 may further include sending the device information of the UAV to the terminal device.

In one embodiment, the method 700 may further include storing the registration certificate.

In one embodiment, the registration certificate may have a validity period, and lifting the flight restrictions on the UAV based on the registration certificate may include querying whether the registration certificate is within the validity period each time when the UAV takes off; and when the registration certificate is within the validity period, lifting the flight restrictions on the UAV.

For example, the registration certificate may have a validity period. Each time when the UAV takes off, the control device may query whether the registration certificate is within the validity period. When the registration certificate is within the validity period, the flight restrictions on the UAV may be lifted. When the registration certificate is out of the validity period, that is, the registration certificate expires, lifting the flight restrictions on the UAV may be refused.

It should be understood that, for the implementation of the various embodiments of the method 700, reference may be made to the description of the method 100 and method 600, and the details of the implementation are not described herein again.

According to the disclosed registration information processing method, the control device uses the identity information of the registrant holding the UAV to generate the registration certificate and lift the flight restrictions on the UAV. As such, more reasonable control of the UAV may be realized, and wasting the space resources or causing insufficient space in the UAV due to the excessively lengthy registration number may be avoided.

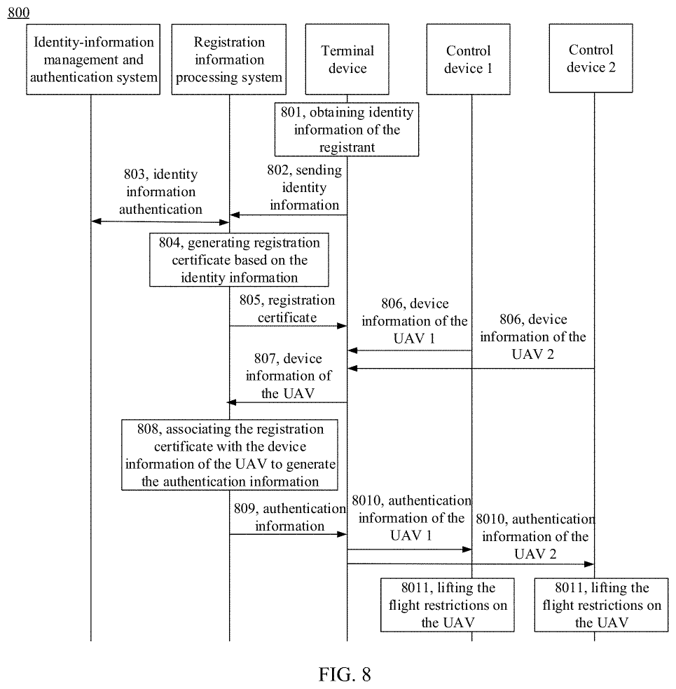

FIG. 8 illustrates a schematic diagram of interaction between a terminal device, a registration information processing system, and a control device according to an embodiment of the present disclosure. Referring FIG. 8, in the following, the registration information processing method will be described in conjunction with a multi-party interaction manner.

In one embodiment, referring to FIG. 8, a control device 1 and a control device 2 may be the control device of a UAV 1 and the control device of a UAV 2, respectively. The control device may be disposed on the corresponding UAV or on a corresponding control terminal. It should be understood that, for illustrative purposes, only the control devices of two UAVs are shown in FIG. 8, and this example is not intended to limit the scope of the present disclosure.

In 801, a terminal device may obtain the identity information of the registrant. The identity information may include, for example, at least one of the information of the certificate hold by the registrant, the biological information of the registrant, or the business information of the registrant.

In 802, the terminal device may send the identity information of the registrant to the registration information processing system.

In 803, the registration information processing system may use an identity-information management and authentication system to authenticate the identity information of the registrant.

In 804, after confirming that the authentication information of the registrant is successfully authenticated, the registration information processing system may generate a registration certificate based on the identity information.

In 805, the registration information processing system may send the registration certificate to the terminal device.

In 806, when obtaining the registration certificate, the registration information processing system may obtain the device information of the UAV 1 from the control device of the UAV1, and obtain the device information of the UAV 2 from the control device of the UAV 2. Before the registration information processing system obtains the device information of the UAV 1 from the control device of the UAV1, and obtains the device information of the UAV 2 from the control device of the UAV 2, the registration information processing system may send request messages respectively to the two control devices to request device information.

In 807, the terminal device may send the device information of the UAV 1 and the device information of the UAV 2 to the registration information processing system.

In 808, the registration information processing system may associate the registration certificate with the device information of the UAV 1 and the device information of the UAV2. For example, authentication information may be respectively generated for the UAV 1 and the UAV 2, the authentication information of the UAV 1 may include a registration certificate and a distinguishing code of the UAV 1 with the distinguishing code may be the device information of the UAV 1, the authentication information of the UAV 2 may include a registration certificate and a distinguishing code of the UAV 2 with the distinguishing code may be the device information of the UAV 2.

In 809, the registration information processing system may send the authentication information of each UAV to the terminal device.

In 810, the terminal device may send the authentication information of the UAV 1 to the control device 1 and send the authentication information of the UAV 2 to the control device 2.

In 8011, the control device of the UAV 1 may compare the device information in the authentication information with preset device information, and when the device information in the authentication information with the preset device information, the flight restrictions on the UAV 1 may be lifted based on the authentication information. The control device of the UAV 2 may compare the device information in the authentication information with preset device information, and when the device information in the authentication information with the preset device information, the flight restrictions on the UAV 2 may be lifted based on the authentication information.

It should be understood that, for the implementation of the various embodiments of the method 800, reference may be made to the description of the method 100, method 600, and method 700, and the details of the implementation are not described herein again.

The method 800 shown in FIG. 8 is only an implementation manner of the embodiments of the present disclosure and should not be construed as limiting the present disclosure. The disclosed registration information processing method may also have other implementations. For example, the distinguishing code in the authentication information of the UAV may not be equal to the device information of the UAV. When the terminal device sends the authentication information to each UAV, the authentication information may also carry the device information of all the UAVs of the registrant, which is convenient for the control device to perform match operation.

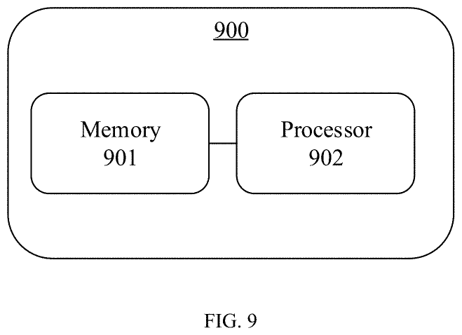

The present disclosure also provides a registration information processing system. FIG. 9 illustrates a schematic structural diagram of a registration information processing system according to an embodiment of the present disclosure. Referring to FIG. 9, the registration information processing system may include: a memory 901 and a processor 902.

In one embodiment, the memory 901 may be configured to store program instructions, and the processor 902 may be configured to call the program instructions to implement the following operations:

obtaining the identity information of the registrant holding the UAV from a terminal device;

generating a registration certificate based on the identity information of the registrant;

obtaining the device information of at least one UAV held by the registrant from the terminal device; and

associating the device information of the at least one UAV with the registration certification.

In one embodiment, when associating the device information of the at least one UAV with the registration certification, the processor 902 may be configured to:

generate corresponding authentication information for each UAV of the at least one UAV, the corresponding authentication information of each UAV including the registration certificate.

In one embodiment, when generating the corresponding authentication information for each UAV of the at least one UAV, the processor 902 may be configured to:

determine a distinguishing code for each of the at least one UAV with the distinguishing code used for distinguishing the UAV within the at least one UAV; and combine the distinguishing code and the registration certificate of each UAV to obtain the corresponding authentication information of the UAV.

In one embodiment, when determining the distinguishing code for each UAV, the processor 902 may be configured to:

determine the distinguishing code for each UAV based on the device information of the UAV.

In one embodiment, the processor 902 may be further configured to:

send the corresponding authentication information of each UAV to the terminal device.

In one embodiment, when sending the corresponding authentication information of each UAV to the terminal device, the processor may be configured to:

when the authentication information includes a distinguishing code for distinguishing the UAV within the at least one UAV, and the distinguishing code is different from the device information, send the device information and the corresponding authentication information of each of the at least one UAV to the terminal device.

In one embodiment, when associating the device information of the at least one UAV with the registration certification, the processor 902 may be configured to:

store the association relationship between the registration certificate and the device information of the at least one UAV in a local database.

In one embodiment, the processor 902 may be further configured to:

obtain a query request, the query request containing the identity information of the registrant or the device information of the UVA;

query the registration certificate based on the identity information of the registrant or the device information of the UVA; and

in response to the query request, send a query response based on the acquired registration certificate.

In one embodiment, the processor 902 may be further configured to:

send the registration certificate to the terminal device.

In one embodiment, the processor 902 may be further configured to:

obtain the contact information of the registrant; and

send the registration certificate based on the contact information.

In one embodiment, the processor 902 may be further configured to:

cancel the association between the registration certificate and the device information of the UAV that has been associated with the registration certificate.

In one embodiment, when obtaining the device information of at least one UAV held by the registrant from the terminal device, the processor 902 may be configured to:

obtain an application request for the registration certificate sent by the terminal device; and

in response to the application request for the registration certificate, obtain the identity information of the registrant.

In one embodiment, when generating the registration certificate based on the identity information of the registrant, the processor 902 may be configured to:

when the identity information of the registrant passes authentication, generate the registration certificate based on the identity information of the registrant.

In one embodiment, the processor 902 may be further configured to: authenticate the identity information of the registrant.

In one embodiment, when authenticating the identity information of the registrant, the processor 902 may be configured to:

send the identity information of the registrant to an identity-information management and authentication system; and

receive the authentication result sent by the identity-information management and authentication system.

In one embodiment, the identity information of the registrant may include:

at least one of the information of the certificate hold by the registrant, the biological information of the registrant, or the business information of the registrant.

In one embodiment, the device information of the UAV may include at least one of the manufacturer, the device model, or the serial number.

The present disclosure also provides a terminal device. The schematic structural diagram in FIG. 9 is consistent with a structural diagram of an exemplary terminal device according to an embodiment of the present disclosure. Referring to FIG. 9, the terminal device may include a memory 901 and a processor 902.

In one embodiment, the memory 901 may be configured to store program instructions, and the processor 902 may be configured to call the program instructions to implement the following operations:

obtaining the identity information of the registrant holding the UAV;

sending the identity information of the registrant to a registration information processing system, so that the registration information processing system generates a registration certificate based on the identity information of the registrant;

obtaining the device information of at least one UVA held by the registrant; and

sending the device information of the at least one UAV to the registration information processing system, so that the registration information processing system associates the registration certificate with the device information of the at least one UAV.

In one embodiment, when obtaining the identity information of the registrant holding the UAV, the processor 902 may be configured to:

determine an application request for the registration certificate according to a detected registration certificate application operation;

send the application request for the registration certificate to a registration information processing system; and

obtain the identity information of the registrant inputted through an interactive device

In one embodiment, when obtaining the device information of at least one UVA held by the registrant, the processor 902 may be configured to:

obtain the device information of the at least one UAV inputted through an interactive device.

In one embodiment, when obtaining the device information of at least one UVA held by the registrant, the processor 902 may be configured to:

obtain the device information of the at least one UAV through a communication interface with the at least one UAV or a control terminal of the UAV.

In one embodiment, the processor 902 may be further configured to:

receive the registration certificate sent by the registration information processing system.

In one embodiment, the processor 902 may be further configured to:

send the registration certificate to one or more UAVs or UAV control terminals of the at least one UAV.

In one embodiment, when sending the registration certificate to one or more UAVs or UAV control terminals of the at least one UAV, the processor 902 may be configured to:

send the device information and the registration certificate of the corresponding UAV to the one or more UAVs or UAV control terminals of the at least one UAV.

In one embodiment, the processor 902 may be further configured to:

receive the corresponding authentication information of each of the at least one UAV sent by the registration certificate processing system, the authentication information including the registration certificate.

In one embodiment, the corresponding authentication information of each UAV further includes a distinguishing code for distinguishing the UAV within the at least one UAV.

In one embodiment, the distinguishing code is determined based on the device information of the UAV.

In one embodiment, the processor 902 may be further configured to:

send the authentication information to one or more UAVs or UAV control terminals of the at least one UAV.

In one embodiment, when sending the authentication information to one or more UAVs or UAV control terminals of the at least one UAV, the processor 902 may be configured to:

send the device information and the authentication information of the corresponding UAV to the one or more UAVs or UAV control terminals of the at least one

UAV.

In one embodiment, when receiving the corresponding authentication information of each of the at least one UAV sent by the registration certificate processing system, the processor 902 may be configured to:

when the authentication information includes a distinguishing code for distinguishing the UAV within the at least one UAV, and the distinguishing code is different from the device information, receive the device information and the corresponding authentication information of each of the at least one UAV sent by the registration information processing system.

In one embodiment, the identity information of the registrant may include:

at least one of the information of the certificate hold by the registrant, the biological information of the registrant, or the business information of the registrant.

In one embodiment, the device information of the UAV may include at least one of the manufacturer, the device model, or the serial number.

The present disclosure also provides a control device. The schematic structural diagram in FIG. 9 is consistent with a structural diagram of an exemplary control device according to an embodiment of the present disclosure. Referring to FIG. 9, the control device may include a memory 901 and a processor 902.

In one embodiment, the memory 901 may be configured to store program instructions, and the processor 902 may be configured to call the program instructions to implement the following operations:

obtaining a registration certificate from a terminal device, the registration certificate generated based on the identity information of the registrant holding the UAV; and

lifting the flight restrictions on the UAV based on the registration certificate.

In one embodiment, the processor 902 may be further configured to obtain device information from the terminal device.

In one embodiment, when lifting the flight restrictions on the UAV based on the registration certificate, the processor 902 may be configured to:

when the device information obtained from the terminal device matches the device information of the UAV, lift the flight restrictions on the UAV based on the registration certificate.

In one embodiment, the processor 902 may be further configured to:

send the device information of the UAV to the terminal device.

In one embodiment, the processor 902 may be further configured to:

store the registration certificate.

In one embodiment, the registration certificate has a validity period, and when lifting the flight restrictions on the UAV based on the registration certificate, the processor 902 may be further configured to:

query whether the registration certificate is within the validity period each time when the UAV takes off; and

when the registration certificate is within the validity period, lift the flight restrictions on the UAV.

The present disclosure also provides a UAV control terminal. The UAV control terminal may include a control device consistent with various embodiments of the present disclosure. The control terminal may include one or more of a remote controller, a smart phone, a tablet computer, a laptop computer, or a wearable device.

The present disclosure also provides an unmanned aerial vehicle (UAV). The UAV may include a control device according to various embodiments of the present disclosure.

It should be understood that the processor in the embodiment of the present application may be an integrated circuit chip and has a signal processing capability. In the implementation process, each exemplary step of the method embodiments described above may be completed by using an integrated logic circuit of hardware in a processor or by instructions in a software form. The processor may be a general-purpose processor, a digital signal processor (DSP), an application specific integrated circuit (ASIC), a field programmable gate array (FPGA), or other programming logic devices, discrete gate or transistor logic devices, discrete hardware components that are able to implement or execute various methods, steps, and logical block diagrams disclosed in the embodiments of the present application. A general-purpose processor may be a microprocessor. The processor may be any conventional processor. The exemplary steps of the methods disclosed in combination with the embodiments of the present application may be directly implemented by a hardware decoding processor, or may be performed by using a combination of hardware and software modules in the decoding processor. The software module may be located in a random storage, a flash memory, a read-only memory (ROM), a programmable read-only memory (PROM) or an electrically erasable programmable read-only memory (EEPROM), a register and other mature storage media in the field. The storage medium may store information including program instructions, etc., and the processor may read the information in the storage medium and completes the exemplary steps of the above methods in combination with hardware.

It should be understood that the memory in the embodiment of the present application may be a volatile memory or a non-volatile memory, or may include both volatile and non-volatile memory. Among them, the non-volatile memory may be a ROM, a PROM, an erasable programmable read-only memory (EPROM), an EEPROM, or flash memory. The volatile memory may be a random access memory (RAM), which is used as an external cache. The RAM may be a static random access memory (SRAM), a dynamic random access memory (DRAM), a synchronous dynamic random access memory (SDRAM), a double data rate SDRAM (DDR SDRAM), an enhanced SDRAM (ESDRAM), a synchlink DRAM (SLDRAM), or a direct rambus RAM (DR RAM). It should be noted that the memory of the systems and methods described herein is intended to include, but is not limited to, these and any other suitable types of memory.

Those of ordinary skill in the art may understand that the units and algorithm steps of each example described in combination with the embodiments disclosed herein can be implemented by electronic hardware, or a combination of computer software and electronic hardware. Whether these functions are performed in hardware or software depends on the specific application and design constraints of the technical solution. Those of ordinary skill in the art can use different methods to implement the described functions for each specific application, but such implementation should not be considered to be beyond the scope of this application.

Those skilled in the art shall clearly understand that, for the convenience and brevity of description, the specific working processes of the systems, devices, and units described above can refer to the corresponding processes in the method embodiments described above, and are not repeated herein again.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

The above-described integrated unit implemented in the form of a software functional unit can be stored in a computer readable storage medium. The above software functional unit is stored in a storage medium and includes instructions for making a computer device (which may be a personal computer, a server, or a network device, etc.) or a processor perform part of the steps of the methods according to the various embodiments of the present disclosure. The storage medium described above may include various media that can store program codes, such as a U disk, a movable hard disk, a read-only memory (ROM), a random access memory (RAM), a magnetic disk, an optical disk, etc.

Those skilled in the art should clearly understand that for the convenience and simplicity of the description, only the division of the above functional modules examples is illustrated. In practical applications, the above function assignment can be completed by different functional modules according to needs, that is, the internal structure of the device may be divided into different functional modules to implement all or part of the functions described above. For the specific operation process of the device described above, reference may be made to the corresponding process in the aforementioned method embodiments, and details are not described herein again.

Finally, it should be noted that the above embodiments are merely illustrative of, but not intended to limit, the technical solutions of the present invention; although the present disclosure has been described in detail with reference to the above embodiments, those skilled in the art should understand that the technical solutions described in the above embodiments may be modified, or part or all of the technical features may be equivalently replaced; and the modifications or substitutions do not depart from the scope of the technical solutions of the embodiments of the present disclosure.

What is claimed is:

1. A registration information processing method, comprising:
obtaining identity information of a registrant holding an unmanned aerial vehicle (UAV) from a terminal device;
generating a registration certificate based on the identity information of the registrant;
obtaining device information of at least one UAV held by the registrant from the terminal device; and
associating the device information of the at least one UAV with the registration certificate.

2. The method according to claim 1, wherein associating the device information of the at least one UAV with the registration certificate includes:
generating corresponding authentication information for each UAV of the at least one UAV, wherein the corresponding authentication information of each UAV includes the registration certificate.

3. The method according to claim 2, wherein generating the corresponding authentication information for each UAV of the at least one UAV includes:
determining a distinguishing code for each UAV of the at least one UAV, wherein the distinguishing code is used for distinguishing the UAV within the at least one UAV; and
combining the distinguishing code and the registration certificate of each UAV to obtain the corresponding authentication information of the UAV.

4. The method according to claim 3, wherein determining the distinguishing code for each UAV of the at least one UAV includes:
determining the distinguishing code for each UAV based on the device information of the UAV.

5. The method according to claim 2, further including:
sending the corresponding authentication information of each UAV to the terminal device.

6. The method according to claim 5, wherein sending the corresponding authentication information of each UAV to the terminal device includes:
when the authentication information includes a distinguishing code for distinguishing the UAV within the at least one UAV, and the distinguishing code is different from the device information, sending the device information and the corresponding authentication information of each UAV of the at least one UAV to the terminal device.

7. The method according to claim 1, wherein associating the device information of the at least one UAV with the registration certification includes:
storing association relationship between the registration certificate and the device information of the at least one UAV in a local database.

8. The method according to claim 1, further including:
obtaining a query request, wherein the query request contains the identity information of the registrant or the device information of the UVA;
querying the registration certificate based on the identity information of the registrant or the device information of the UVA; and
in response to the query request, sending a query response based on the acquired registration certificate.

9. The method according to claim 1, further including:
sending the registration certificate to the terminal device.

10. The method according to claim 1, further including:
obtaining contact information of the registrant; and
sending the registration certificate based on the contact information.

11. The method according to claim 1, further including:
cancelling association between the registration certificate and the device information of the UAV that has been associated with the registration certificate.

12. The method according to claim 1, wherein obtaining the device information of at least one UAV held by the registrant from the terminal device includes:
obtaining an application request for the registration certificate sent by the terminal device; and
in response to the application request for the registration certificate, obtaining the identity information of the registrant.

13. The method according to claim 1, wherein generating the registration certificate based on the identity information of the registrant includes:
when the identity information of the registrant passes an authentication, generating the registration certificate based on the identity information of the registrant.

14. The method according to claim 13, further including:
authenticating the identity information of the registrant.

15. The method according to claim 14, wherein authenticating the identity information of the registrant includes:
sending the identity information of the registrant to an identity-information management and authentication system; and
receiving the authentication result sent by the identity-information management and authentication system.

16. The method according to claim 1, wherein:
the identity information of the registrant includes at least one of a certificate hold by the registrant, biological information of the registrant, or business information of the registrant.

17. The method according to claim 1, wherein:
the device information of each UAV of the at least one UAV includes at least one of a manufacturer, a device model, or a serial number.

18. A registration information processing system, comprising:
a memory, configured to store program instructions; and
a processor, when the program instructions being executed, configured to:
obtain identity information of a registrant holding a UAV from a terminal device;
generate a registration certificate based on the identity information of the registrant;
obtain device information of at least one UAV held by the registrant from the terminal device; and
associate the device information of the at least one UAV with the registration certificate.

19. The system according to claim 18, wherein when associating the device information of the at least one UAV with the registration certificate, the processor is configured to:
generate corresponding authentication information for each UAV of the at least one UAV, wherein the corresponding authentication information of each UAV includes the registration certificate.

20. The system according to claim 19, wherein when generating the corresponding authentication information for each UAV of the at least one UAV, the processor is configured to:
determine a distinguishing code for each UAV of the at least one UAV, wherein the distinguishing code is used for distinguishing the UAV within the at least one UAV; and
combine the distinguishing code and the registration certificate of each UAV to obtain the corresponding authentication information of the UAV.
